(19) United States
(12) Patent Application Publication
(10) Pub. No.: US 2016/0003125 A1
(43) Pub. Date: Jan. 7, 2016

(54) COOLANT CONTROL VALVE OF ENGINE

(71) Applicants: Hyundai Motor Company, Seoul (KR); Kia Motors Corporation, Seoul (KR)

(72) Inventor: Philgi LEE, Suwon-si (KR)

(73) Assignees: Hyundai Motor Company, Seoul (KR); Kia Motors Corporation, Seoul (KR)

(21) Appl. No.: 14/543,009

(22) Filed: Nov. 17, 2014

(30) Foreign Application Priority Data
Jul. 2, 2014 (KR) 10-2014-0082305

(51) Int. Cl. F01P 7/14; F16K 5/04; F16K 5/10; F01P 3/02

(52) U.S. Cl. CPC F01P 7/14; F01P 3/02; F16K 5/0407; F16K 5/10; F16K 5/0414; F01P 2007/146; F01P 2003/024

(57) ABSTRACT

A coolant control valve of an engine may include a cylindrical valve that coolant flows in an interior circumference thereof, a coolant outlet formed from a central space to an outside of the cylindrical valve, and a convex surface formed on an exterior circumference corresponding to the outlet, a valve housing that the cylindrical valve is rotatably disposed in, and a driving portion that is disposed at one side of the valve housing to rotate the cylindrical valve, a main pipe that is engaged with the valve housing, and a sealing member that a curved surface is formed on corresponding to the convex surface of the cylindrical valve, and an elastic member that elastically pushes the sealing member toward an exterior circumference of the cylindrical valve, in which a separation wall that separates coolant flowing through the outlet of the cylindrical valve is formed in the main pipe.

### CROSS-REFERENCE TO RELATED APPLICATION

The present application claims priority to Korean Patent Application No. 10-2014-0082305 filed Jul. 2, 2014, the entire contents of which is incorporated herein for all purposes by this reference.

### BACKGROUND OF THE INVENTION

1. Field of the Invention

The present invention is related to a coolant control valve of an engine that separates coolant that is exhausted from a coolant control valve and simultaneously controls the coolant that is supplied to a left side cylinder head and a right side cylinder head.

2. Description of Related Art

The engine generates a torque by burning fuel, and exhausts the remainder in thermal energy. Particularly, cooling water absorbs heat while circulating the engine, a heater and a radiator and dissipates the heat to an outside of the engine.

If a cooling water temperature of the engine is low to elevate oil viscosity, it is a trend that friction force and fuel consumption increases and a temperature of exhaust gas rises slowly resulting in prolonging a time period of catalyst activation and making a quality of the exhaust gas poor. Along with this, there is a trend that a time period for bringing a heater function to a normal level takes a long time to make occupants and a driver to feel cold.

If the cooling water temperature of the engine is excessive, knocking takes place, and, if ignition timing is adjusted for suppressing the knocking, performance is liable to become poor. And, if a lubrication oil temperature is excessive, a lubrication action is liable to become poor.

Accordingly, a specific part of an engine is maintained to a high temperature and another part thereof is maintained to a lower temperature, wherein one integrated flow control valve is applied to control several cooling elements.

Particularly, a V type engine has two cylinder head water jackets or two block water jackets at left and right sides, coolant chambers are formed at each cylinder head or block, and two discharge pipes are formed on one integrated flow control valve corresponding to the coolant chambers.

Meanwhile, because two discharge pipes are formed to be connected to cylinder head or block, overall volume, the number of assembly components, and weight of the control valve are also increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a coolant control valve of an engine having advantages of decreasing the number of discharge pipes of one integrated flow control valve that supplies left and right sides of a cylinder head or block with coolant.

According to various aspects of the present invention, a coolant control valve of an engine may include a cylindrical valve that coolant flows in an interior circumference thereof, a coolant outlet formed from a central space to an outside of the cylindrical valve, and a convex surface formed on an exterior circumference corresponding to the outlet, a valve housing that the cylindrical valve is rotatably disposed in an inside portion thereof based on a length direction central axis, and a driving portion that is disposed at one side of the valve housing to rotate the cylindrical valve, a main pipe that is engaged with the valve housing corresponding to a position of the outlet of the cylindrical valve, the coolant flowing therein through the outlet, and a sealing member that a curved surface is formed on corresponding to the convex surface of the cylindrical valve, the main pipe being inserted thereinto to prevent the leakage of the coolant that flows in the main pipe through the outlet and an elastic member that elastically pushes the sealing member toward an exterior circumference of the cylindrical valve, in which a separation wall that separates coolant flowing through the outlet of the cylindrical valve is formed in the main pipe along the length direction of the main pipe, and a first diverging pipe through which coolant flowing in one side based on the separation wall is diverged from the main pipe and a second diverging pipe through which coolant flowing in another side based on the separation wall is diverged from the main pipe.

The separation wall may include a protruded portion that is formed from an end portion of the main pipe toward an exterior surface of the cylindrical valve

The protruded portion may be formed at a position corresponding to a central portion of the convex surface of the cylindrical valve.

The separation wall may be formed along a central portion of the main pipe.

The protruded portion may be an elastic material that elastically contacts the exterior surface of the cylindrical valve.

The protruded portion may include a first elastic contact member that can be bent toward the one side based on the separation wall and one side surface of one end of the first elastic contact member elastically contacts the convex surface, and a second elastic contact member that is bendable toward the other side based on the separation wall and the other side surface of one end of the second elastic contact member elastically contacts the convex surface.

The first diverging pipe may be connected to a left side of a cylinder head or a left side block of an engine and the second diverging pipe may be connected to a right side of the cylinder head or a right side block of the engine.

Supply pipes may be disposed on the valve housing corresponding to the outlet of the cylindrical valve to supply a heater, a radiator, or a transmission oil warmer with coolant, and may simultaneously control the coolant that is supplied to the heater, the radiator, or the transmission oil warmer.

The sealing member may have a cylindrical shape, a front end portion of the sealing member may contact the convex surface that is formed at the exterior surface of the cylindrical valve and a rear side interior surface slidably contacts an exterior surface of the main pipe.

In accordance with the present invention for realizing the objects, a separation wall is formed in a main pipe that supplies left and right sides of a cylinder head with coolant from one coolant control valve, and a protruded portion is formed toward a cylindrical valve from the separation wall such that the coolant is separated to be supplied to left and right sides of the cylinder head.

Further, the number of the outlet pipes that supply left and right sides of the cylinder head with coolant from one coolant control valve is decreased, and therefore overall volume, the number of assembly components, and weight are reduced and overall cost is saved.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an overall cross-sectional view of an exemplary coolant control valve of an engine that is related to the present invention.

FIG. 2 is a partial cross-sectional view of the exemplary coolant control valve of the engine according to the present invention.

FIG. 3 is a partial cross-sectional view of a main pipe of the exemplary coolant control valve of the engine according to the present invention.

FIG. 4 is a partial cross-sectional view of a main pipe of a coolant control valve of an engine according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

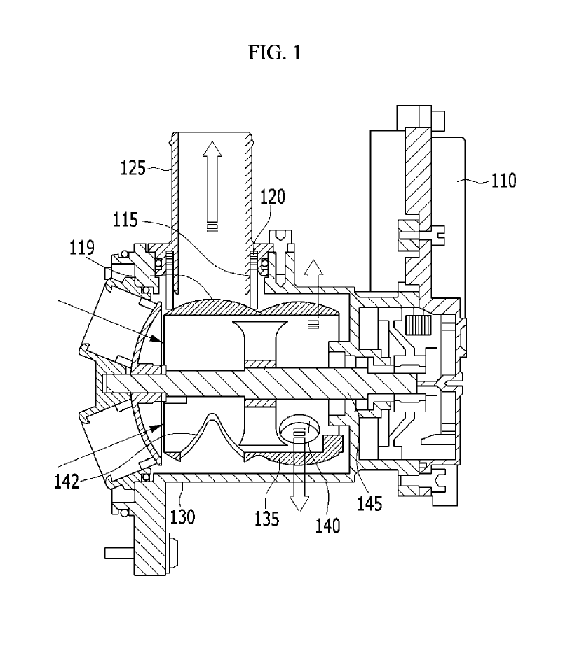

FIG. 1 is an overall cross-sectional view of a coolant control valve of an engine that is related to the present invention.

Referring to FIG. 1, a coolant control valve of an engine includes a motor housing 110 that a motor is built therein, a rotation rod 145 that is rotated by the motor, a cylindrical valve that is rotated by the rotation rod 145, a valve housing 130 that the cylindrical valve 135 is rotatably disposed therein, a main pipe 125 that connects to an inner space of the cylindrical valve 135 corresponding to an outlet of the cylindrical valve 135, a sealing member 115 that prevents the leaks of coolant between the main pipe 125 and the cylindrical valve 135, and an elastic member 120 that elastically pushes the sealing member 115 to a convex surface 119 that is formed on an exterior surface of the cylindrical valve 135.

The sealing member 115 has a cylindrical shape, a front end portion thereof contacts the convex surface 119 that is formed on an exterior surface of the cylindrical valve 135, and the main pipe 125 is inserted into a rear side of the sealing member 115, wherein the interior circumference of the sealing member slides with the exterior circumference of the main pipe 125.

The elastic member 120 has a wave spring type, a rear side thereof is supported by the main pipe 125, a front side thereof elastically pushes the sealing member 115 toward the cylindrical valve 135.

The cylindrical valve 135 has a pipe that a central portion thereof is hollow and both end portions thereof are opened, and outlets 140 and 142 are formed to connect a central space with an outside. And, coolant flows into one side of the cylindrical valve 135 (left side of FIG. 1).

If the motor that is built in the motor housing 110 rotates the cylindrical valve 135 through the rotation rod 145, the outlets 140 and 142 correspond to the main pipe 125. And, the coolant is supplied to the coolant jacket of both sides of the cylinder head through the outlets 140 and 142 and the main pipe 125.

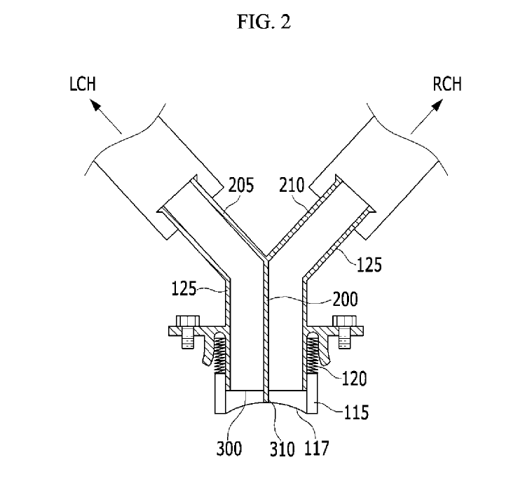

FIG. 2 is a partial cross-sectional view of a coolant control valve of an engine according to various embodiments of the present invention.

Referring to FIG. 2, a coolant control valve of an engine includes a sealing member 115, an elastic member 120, a main pipe 125, a separation wall 200, a first diverging pipe 205, and a second diverging pipe 210.

A concave curved surface 117 is formed on a front end surface of the sealing member 115, and the curved surface 117 slidably contacts the convex surface 119 of the cylindrical valve 135.

An interior circumference of a rear end portion of the sealing member 115 slidably contacts on an exterior circumference of a front end portion of the main pipe 125.

The elastic member 120 is a wave spring type, one end thereof is supported by the main pipe 125, and the other end thereof elastically pushes the sealing member 115 toward the cylindrical valve 135.

In various embodiments of the present invention, a separation wall 200 is formed along a central portion of the main pipe 125 so as to separate coolant that flows in the main pipe 125 through the sealing member 115.

A protruded portion 310 is formed at an end portion surface 300 or a front end surface of the main pipe 125, the protruded portion 310 is extended from the separation wall 200 toward an exterior surface of the cylindrical valve 135. The coolant that passes the sealing member 115 and the main pipe 125 is effectively separated by the separation wall 200 and the protruded portion 310.

Further, a rear end portion of the main pipe 125 is diverged into a first diverging pipe 205 and a second diverging pipe 210, the first diverging pipe 205 supplies a coolant chamber of one side cylinder head with coolant that flows into a left side of the separation wall 200, and the second diverging pipe 210 supplies a coolant chamber of the other side cylinder head with coolant that flows into a right side of the separation wall 200.

In various embodiments of the present invention, the first diverging pipe can be connected to a coolant jacket of a left side of the cylinder head or a block of an engine, and the second diverging pipe can be connected to a coolant jacket of a right side of the cylinder head or a block of an engine.

Further, supply pipes are disposed on the valve housing corresponding to the inlet or the outlet of the cylindrical valve so as to supply a heater, a radiator, or a transmission oil warmer with coolant, and the coolant that is supplied to the heater, the radiator, or the transmission oil warmer depending on the rotation position of the cylindrical valve is respectively simultaneously controlled.

In various embodiments of the present invention, the coolant that is supplied to a left side cylinder head and a right side cylinder head is simultaneously controlled through the control of the cylindrical valve 135, the number of the main pipes 125 is decreased, and one main pipe 125 is used to simultaneously control the coolant that is supplied to both sides of the cylinder head. Particularly, this invention can be applied to an engine having two cylinder head of a V type.

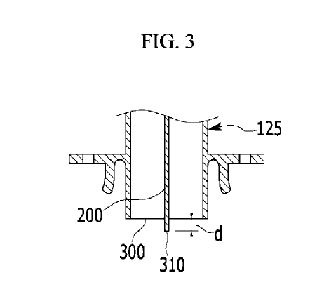

FIG. 3 is a partial cross-sectional view of a main pipe of a coolant control valve of an engine according to various embodiments of the present invention.

Referring to FIG. 3, a front end surface 300 of the main pipe has a plane shape, the protruded portion that is extended from the separation wall protrudes as long as a predetermined distance (d) from the front end surface toward the cylindrical valve. The distance (d) that the protruded portion protrudes can be changed depending on a design specification of a user.

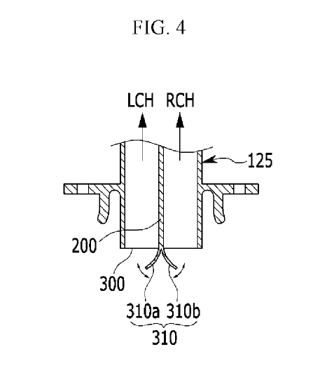

FIG. 4 is a partial cross-sectional view of a main pipe of a coolant control valve of an engine according to various embodiments of the present invention.

Referring to FIG. 4, the protruded portion 310 that is extended from the separation wall 200 can be elastically bent such as a plate spring.

More specifically, the protruded portion 310 includes a first elastic contact member 310a and a second elastic contact member 310b, and the first elastic contact member 310a and the second elastic contact member 310b unfold both end sides with respect to the separation wall 200.

One surface of an end portion of the first elastic contact member 310a elastically contacts the convex surface 119 of the cylindrical valve 135, the other surface of an end portion of the second elastic contact member 310b elastically contacts the convex surface 119 of the cylindrical valve 135. Accordingly, the mixture of the coolant is prevented and the coolant is further effectively separated.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A coolant control valve of an engine, comprising:
a cylindrical valve that coolant flows in an interior circumference thereof, a coolant outlet formed from a central space to an outside of the cylindrical valve, and a convex surface formed on an exterior circumference corresponding to the outlet;
a valve housing that the cylindrical valve is rotatably disposed in an inside portion thereof based on a length direction central axis, and a driving portion that is disposed at one side of the valve housing to rotate the cylindrical valve;
a main pipe that is engaged with the valve housing corresponding to a position of the outlet of the cylindrical valve, the coolant flowing therein through the outlet; and
a sealing member that a curved surface is formed on corresponding to the convex surface of the cylindrical valve, the main pipe being inserted thereinto to prevent leakage of the coolant that flows in the main pipe through the outlet, and an elastic member that elastically pushes the sealing member toward an exterior circumference of the cylindrical valve,
wherein a separation wall that separates coolant flowing through the outlet of the cylindrical valve is formed in the main pipe along a length direction of the main pipe, and a first diverging pipe through which coolant flowing in one side based on the separation wall is diverged from the main pipe and a second diverging pipe through which coolant flowing in another side based on the separation wall is diverged from the main pipe.

2. The coolant control valve of the engine of claim 1, wherein the separation wall includes a protruded portion that is formed from an end portion of the main pipe toward an exterior surface of the cylindrical valve.

3. The coolant control valve of the engine of claim 2, wherein the protruded portion is formed at a position corresponding to a central portion of the convex surface of the cylindrical valve.

4. The coolant control valve of the engine of claim 2, wherein the separation wall is formed along a central portion of the main pipe.

5. The coolant control valve of the engine of claim 2, wherein the protruded portion is an elastic material that elastically contacts the exterior surface of the cylindrical valve.

6. The coolant control valve of the engine of claim 5, wherein the protruded portion includes:
a first elastic contact member that is bendable toward the one side based on the separation wall and one side surface of one end of the first elastic contact member elastically contacts the convex surface; and
a second elastic contact member that is bendable toward the other side based on the separation wall and another side surface of one end of the second elastic contact member elastically contacts the convex surface.

7. The coolant control valve of the engine of claim 2, wherein the first diverging pipe is connected to a left side of a cylinder head or a left side block of an engine and the second diverging pipe is connected to a right side of the cylinder head or a right side block of the engine.

8. The coolant control valve of an engine of claim 2, wherein supply pipes are disposed on the valve housing corresponding to the outlet of the cylindrical valve to supply a heater, a radiator, or a transmission oil warmer with coolant, and simultaneously control the coolant that is supplied to the heater, the radiator, or the transmission oil warmer.

9. The coolant control valve of the engine of claim 2, wherein the sealing member has a cylindrical shape, a front end portion of the sealing member contacts the convex surface that is formed at the exterior surface of the cylindrical valve and a rear side interior surface slidably contacts an exterior surface of the main pipe.
